(19) United States
(12) Patent Application Publication
(10) Pub. No.: US 2005/0165983 A1
(43) Pub. Date: Jul. 28, 2005

(54) System and method for processing data in kernel area by a user command

(75) Inventor: Sang-Jun Nam, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/918,918

(22) Filed: Aug. 16, 2004

(30) Foreign Application Priority Data
Jan. 26, 2004 (KR) 2004-4848

(51) Int. Cl. G06F 3/00

(52) U.S. Cl. 710/52

(57) ABSTRACT

Disclosed is a data processing method of a kernel area according to a command of a user in a data processing system having a kernel mode used as an operation mode of the kernel area and a user mode used as an operation mode of an user area. The data processing method includes the steps of extracting data to be processed from a data storage part in response to the command of the user in the kernel mode if a predetermined data process command occurs in the user mode by the command of the user; storing the data to be processed in a kernel buffer; transferring basic information of the data to be processed to the user mode; creating a second data processing function corresponding to a first data processing function using the basic information in the kernel mode if the first data processing function using the basic information is initiated in the user mode; and processing the data to be processed by using the data processing function. Accordingly, data transmission efficiency is improved by reducing the excessive overheads occurring due to frequent data transmission between a user mode and a kernel mode when transmitting multimedia data. Also, it is possible to simplify interfaces of applications based on the RTP by creating RTP packets in a kernel area.

### PRIORITY

This application claims priority to an application entitled “System and Method for Processing Data in Kernel Area by Command of User” filed in the Korean Intellectual Property Office on Jan. 26, 2004 and assigned Serial No. 2004-4848, the contents of which are hereby incorporated by reference.

### BACKGROUND OF THE INVENTION

1. Field of the Invention

The present invention relates to a system and a method for processing data in a kernel area according to a command of a user, and more particularly to a system and a method for transferring data between a user mode and a kernel mode.

2. Description of the Related Art

In general, all systems have an operating system (OS) for sending user commands to devices by interpreting the user commands. Core operations of the OS are executed in a kernel area. In the present application, an operation mode of system operation modes for processing data between a kernel and a user through an interface is called “user mode” and an operation mode for processing data in the kernel area is called “kernel mode”.

FIGS. 1 and 2 show a conventional data processing system in the kernel area. In particular, FIG. 1 illustrates a procedure of transferring multimedia data through a real-time transport protocol (RTP) in the conventional data processing system. Herein, the RTP is formed in order to transfer multimedia data in real time. Also, conventionally, the RTP is realized in such a manner that the RTP is employed in a user mode.

Referring to FIG. 1, RTP headers formed together with multimedia data by a multimedia application 10 in the user mode are delivered to devices through predetermined process modules 20 operating in a kernel mode in the kernel area of the conventional data processing system. That is, the RTP headers are delivered to network interfaces such as an Internet protocol (IP) 22, an Ethernet (ETH) 23, and an Ethernet driver (ETHDRV) 24 through a user datagram protocol (UDP) 21. Accordingly, multimedia data, which are continuously and repeatedly created together with RTP data and transferred to a lower layer, are excessively duplicated and exchanged between a buffer of a user area and a buffer of a kernel area.

FIG. 2 shows a procedure of transferring data in the conventional data processing system in the kernel area. Referring to FIG. 2, the procedure of transferring data between an application 30 executed in a user mode and functions executed in a kernel mode will be described below.

Generally, the procedure of transferring data between the application 30 executed in the user mode and the functions executed in the kernel mode is carried out through a data read command and a data write command. Also, data copy and context exchange procedures are repeatedly performed.

If the data read command occurs in the application 30, corresponding data is read from a database 41 and are stored in a kernel buffer 42 in the kernel mode. Thereafter, the data stored in the kernel buffer 42 are copied so as to be delivered to a user buffer 32. Meanwhile, if the data write command occurs in the application 30, data stored in the buffer of the user area are copied so as to be delivered to the kernel buffer 42 by means of a system call (sendto).

FIG. 3 is a flowchart showing a conventional method of processing data in the kernel area in accordance with a user command. In particular, FIG. 3 shows a procedure of transferring data between system areas operating as the kernel mode and the user mode in order to process data. Referring to FIG. 3, first, if at step S11 data process is required by a predetermined data processing command in a user mode 60, at step S13 data to be processed is extracted from a data storage area DB 41 (FIG. 2) of the kernel mode 50 and are stored in a kernel buffer at step S15. Also, after the data to be processed, witch has been formed in a predetermined unit, is transferred at step S17 to a side of a user mode 60 by the predetermined unit, a process result of the transferred data is received from the user mode 60 at step S23. Meanwhile, at step S19 the data transferred in step S17 is stored in a user area buffer in the user mode, the required process is performed with respect to the data, and the data subject to the required process is transferred to a side of a kernel mode 50 at step S23. Thereafter, the data received from the user mode 60 is transferred to device units at step S25.

Steps S17, S19, S21, and S23 are repeatedly performed until it is determined that all data to be processed has been processed at step S27.

Data transfer is repeatedly performed between the kernel mode 50 and the user mode 60 in order to process predetermined data in the conventional method, so that data copy and context exchange procedures are repeatedly performed. Accordingly, although binary files of a small size can optimally be transferred, excessive overheads of the streaming data may occur when streaming data such as multimedia data, e.g., audio data, video data, are transferred.

### SUMMARY OF THE INVENTION

Accordingly, the present invention has been made to solve the above-mentioned problems occurring in the prior art, and a first object of the present invention is to provide a system and a method for processing data, which can raise transmission efficiency of multimedia data.

A second object of the present invention is to provide a system and a method for processing data, which can improve data transmission efficiency by reducing excessive overheads generated due to frequent data transmission between a user mode and a kernel mode when transmitting data.

A third object of the present invention is to provide a system and a method for processing data, which can improve data transmission efficiency by realizing a real-time transport protocol (RTP) in a kernel area.

In order to accomplish these objects, there is provided a data processing system in a kernel area according to a user command, the data processing system including: a database; a user area input/output control part for calling an input/output system instruction for performing a command by using predetermined parameters after establishing the predetermined parameters required for performing the command if the command for data transfer occurs in a user area; a kernel area input/output control part for controlling input/output in the kernel area in response to a call of the input/output system call; and a second buffer storing data extracted from the database therein with a transmission unit by a control command of the kernel area input/output control part, wherein the kernel area input/output control part adds a protocol header for transmitting data to each part of data in the transmission unit stored in the second buffer by using the predetermined parameters.

Also, in order to accomplish these objects, there is provided a data processing method of a kernel area according to a user command in a data processing system having a kernel mode used as an operation mode of the kernel area and a user mode used as an operation mode of a user area, the data processing method including the steps of extracting data to be processed from a data storage part in response to the user command in the kernel mode if a predetermined data process command occurs in the user mode in response to the command of the user; storing the data to be processed in a kernel buffer; transferring basic information about the data to be processed to the user mode; creating a second data processing function corresponding to a first data processing function using the basic information in the kernel mode if the first data processing function using the basic information is called in the user mode; and processing the data to be processed by using the data processing function.

### BRIEF DESCRIPTION OF THE DRAWINGS

The above and other objects, features and advantages of the present invention will be more apparent from the following detailed description taken in conjunction with the accompanying drawings, in which:

FIGS. 1 and 2 are diagrams showing a conventional data processing system in a kernel area;

FIG. 3 is a diagram showing a convention method of processing data in a kernel area under a user command;

FIG. 4 is a diagram of a data processing system in a kernel area according to a first embodiment of the present invention;

FIG. 5 is a diagram of a data processing system in a kernel area according to a second embodiment of the present invention;

FIG. 6 is a program listing a portion of input/output system function codes according to first and second embodiments of the present invention;

FIG. 7 is a flowchart showing a method of processing data under a user command in a kernel area according to first and second embodiments of the present invention; and

FIG. 8 is a graph representing a result obtained through performance estimation for a data processing system according to the present invention.

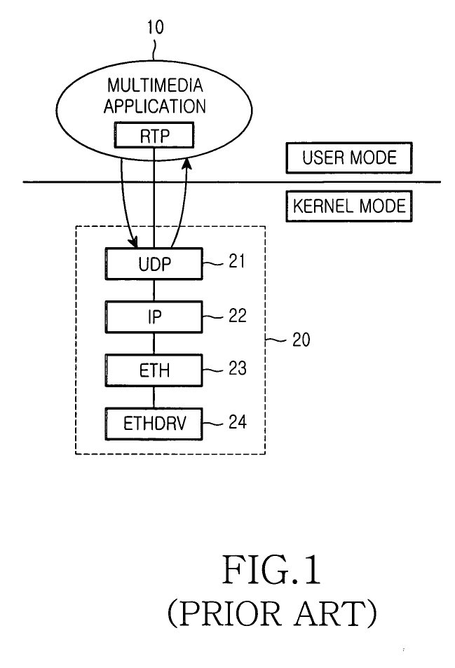

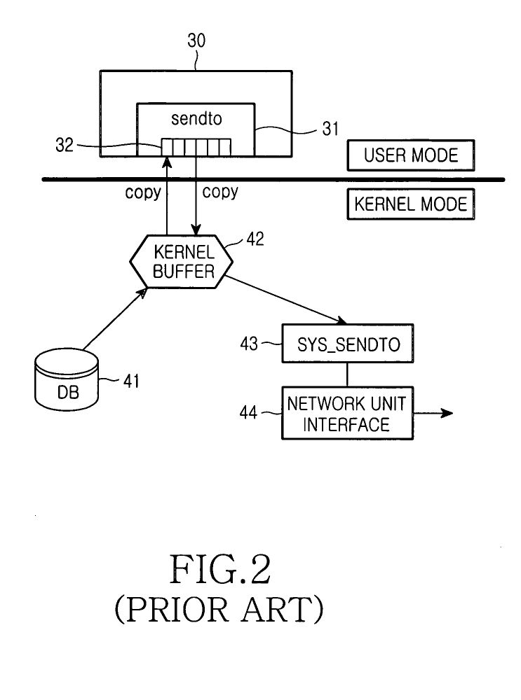

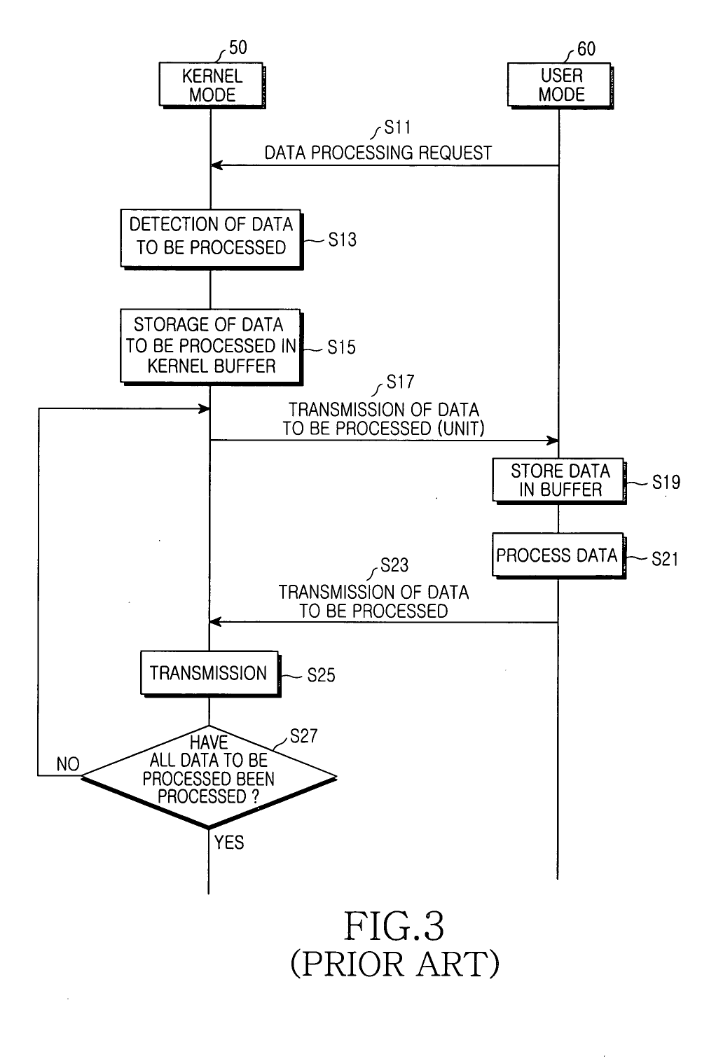

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

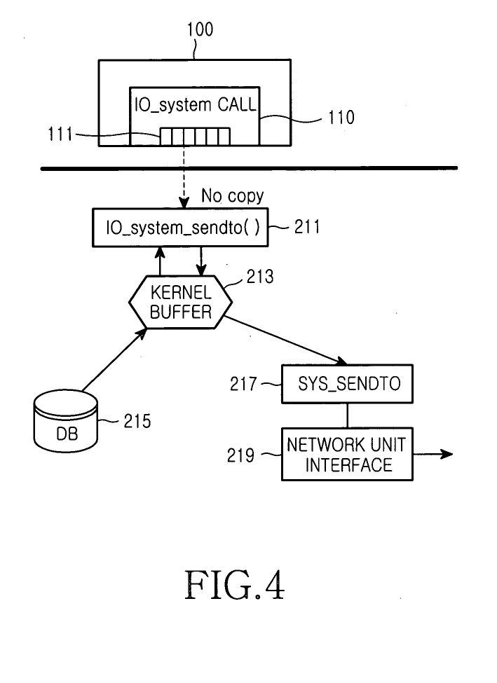

FIG. 4 shows a diagram of a data processing system in a kernel mode according to a first embodiment of the present invention. Referring to FIG. 4, the data processing system in the kernel mode according to the first embodiment of the present invention includes a user area input/output control part 110 executing an input/output system call (IO_system_call) if a command for data transmission occurs in a user area 100, a buffer 111 provided for storing data required for input/output control. A kernel area input/output control part 211 for controlling input/output in the kernel area in response to an input/output system call of the user area input/output control part 110. A kernel buffer 213 provided for storing data extracted from the database (DB) 215 by a control command of the kernel area input/output control part 211, and a data transmission part (sys_sendto) 217 delivering data from the kernel buffer 213 to a network unit interface 219.

Herein, the kernel area input/output control part 211 is a function, e.g., application program interface, (hereinafter, referred to as “API”) created in response to the input/output system call from the user area. The kernel area input/output control part 211 adds an RTP header to each predetermined unit data stored in the kernel buffer and transfers data to network units by using coder-decoder (CODEC) information if necessary.

Also, the data transmission part (sys_sendto) 217 is realized in the form of a function.

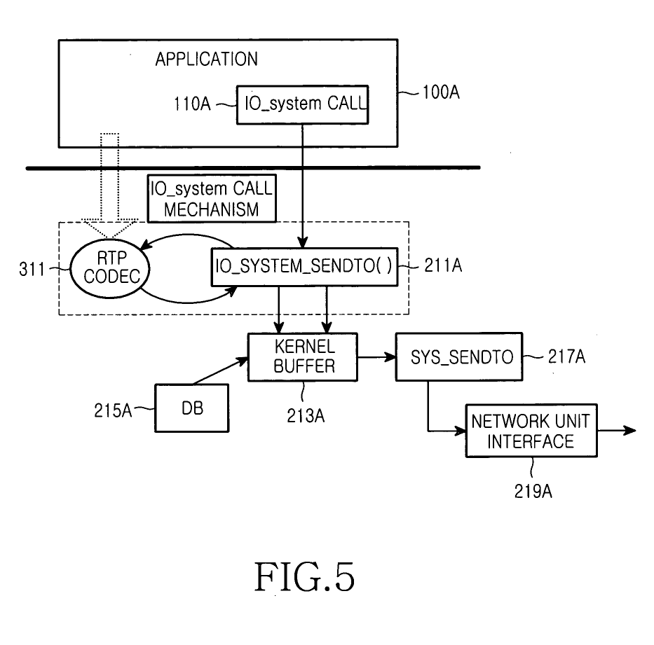

FIG. 5 is a diagram showing a data processing system in a kernel area according to a second embodiment of the present invention. FIG. 5 shows an example in which an RTP is realized in an area operating as a kernel mode. Herein, an RTP CODEC 311 provides CODEC information for processing RTP packets for a function (IO_system_sendto ( )) 211 A called by an IO_system call 110A from an application area 100A.

A DB 215A, a kernel buffer 213A, a data transmission part (sys_sendto) 217A, and a network unit interface 219A are operated corresponding to the DB 215 (FIG. 4), the kernel buffer 213 (FIG. 4), the data transmission part (sys_sendto) 217 (FIG. 4), and the network unit interface 219 (FIG. 4), respectively.

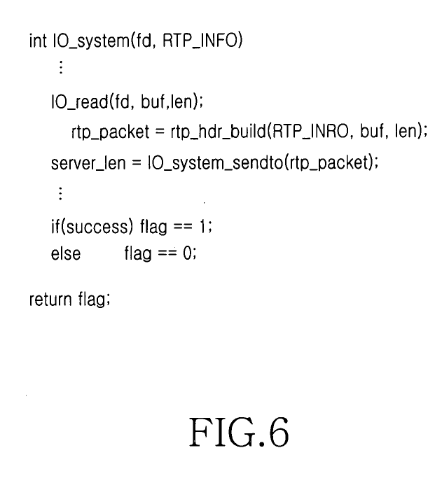

FIG. 6 shows a portion of code of the input/output system call according to the first and the second embodiments of the present invention. That is, FIG. 6 shows a portion of code of the IO_system call executed in a kernel of a server employing an RTP protocol.

Hereinafter, when a data processing system according to the present invention is a server system for providing predetermined data, e.g., multimedia data, to client systems, a procedure of processing data in the data processing system will be described with reference to FIG. 6. First, the data processing system calls a function (IO_system (fd, RTP_INFO)) of the application 100 executed in a user mode in response to requests from the client systems. Also, the data processing system establishes communication conditions for transferring data to the client systems.

The application 100 (IO_system (fd, RTP_INFO)) calls a function of a kernel area ‘IO_system_sendto ( )’ through the input/output system call in order to extract multimedia data information corresponding the requests of the client systems. That is, the application 100 delivers the multimedia data information corresponding the requests of the client systems to the kernel area by means of ‘IO_system_sendto ( )’.

Meanwhile, an IO_read function (IO_read (fd, buf, len)) has a pointer of a storage unit to which data will be transferred and reads the data from the storage unit by using the pointer. Also, an rtp_hdr_build function (rtp_hdr_build (RTP_INFO, buf, len)) creates an RTP packet by using the data read through the IP_read function and an RTP header field (RTP_INFO) sent from the application of the user area.

The created RTP packet is sent to a network interface through an User Diagram Protocol (UDP) protocol by using the IO_system_sendto function as an IO_system call mechanism method.

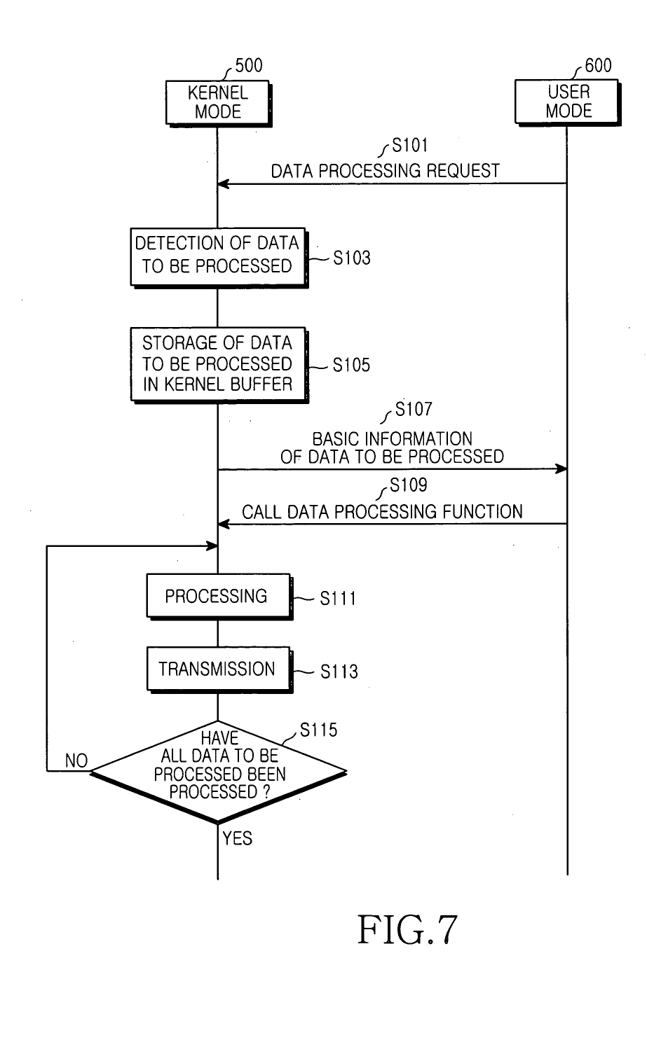

FIG. 7 is a flowchart showing a method of processing data under a user command in the kernel area according to the first and the second embodiments of the present invention. In particular, FIG. 7 shows a method of transferring data between a system area operating as a kernel mode 500 and a user area operating as a user mode 600 in order to process data.

Referring to FIG. 7, if at step S101, a user requires data process by means of a predetermined data processing command in the user mode 600, at step S103 data to be processed is extracted from a data storage area, DB 215 (FIG. 4) in the kernel mode 500 and stored in the kernel buffer at step S105. Also, basic information of the data to be processed, e.g., a pointer and a length, is transferred at step S107 to a side of the user mode 600. Then, a data processing function (IO_system_sendto ( )) of the kernel area is called through a system call in the user mode at step S109.

Thereafter, at step S111 the data is processed through the data processing function (IO_system sendto( )) in the kernel mode 500. The processed data is transferred to the devices at step S113. Steps S111 and S113 are repeatedly performed until it is determined that all data to be processed have been processed.

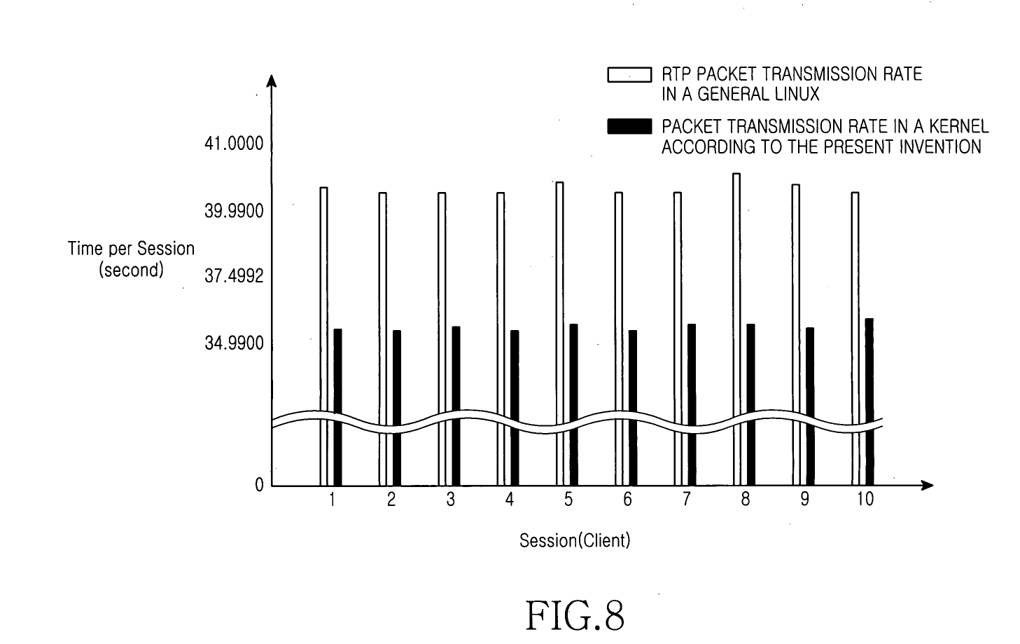

FIG. 8 is a graph representing results obtained through performance estimation for the data processing system according to the present invention.

The performance estimation is carried out through a Linux operating system allowing users to check sources of the kernel. Also, the performance estimation is achieved by comparing transmission rate of RTP data, which are transferred through the UDP protocol by using the conventional method, with transmission rate of RTP data transferred by calling the IO_system call while accommodating the RTP protocol in the kernel according to the present invention.

Also, since RTP packets are generally transferred with transmission interval of 20 to 30 ms, RTP packets according to the performance estimation are transferred with a delay of about 30 ms, and each RTP packets has a size of 32 bytes. In addition, the performance estimation is achieved under a condition in which 10 clients are connected to a multimedia server by considering that a multimedia server is generally connected to a plurality of clients. Also, the present invention may be achieved under another condition in which one client has 1000 packets.

Referring to FIG. 8, it can be understood that a packet transmission rate in a kernel according to the present invention is much faster than an RTP packet transmission rate in a general Linux operating system.

As described above, according to the present invention, data transmission efficiency is improved by reducing the excessive overheads occurring due to frequent data transmission between a user mode and a kernel mode when transmitting multimedia data. Also, it is possible to increase data transmission rate through an RTP by creating RTP packets in a kernel area and to simplify interfaces of applications based on the RTP.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

1. A data processing system in a kernel area according to a command of a user, the data processing system comprising:
a database;
a user area input/output control part used for initiating an input/output system call for performing a command if the command for data transfer occurs in a user area, wherein the command is performed by using predetermined parameters after establishing the predetermined parameters required for performing the command;
a kernel area input/output control part for controlling input/output in the kernel area in response to initiation of the input/output system call; and
a second buffer for storing data extracted from the database with a transmission unit by a control command of the kernel area input/output control part, wherein the kernel area input/output control part adds a protocol header by using the predetermined parameters for transmitting data to each of data segments in the transmission unit stored in the second buffer.

2. The data processing system as claimed in claim 1, wherein the kernel area input/output control part adds a protocol header to each transmission unit data segments for real-time transmission.

3. The data processing system as claimed in claim 2, wherein the kernel area input/output control part transfers transmission data segments to a network device, which performs data transmission/receiving in relation to an external device, by using coder-decoder (CODEC) information for processing the transmission data segments having the protocol header for real-time transmission.

4. The data processing system as claimed in claim 1, wherein the kernel area input/output control part creates an application program interface corresponding to the input/output system call in response to the input/output system call of the user area input/output control part and controls input/output of the kernel area by using the application program interface.

5. A data processing method of a kernel area according to a user command in a data processing system having a kernel mode used as an operation mode of the kernel area and a user mode used as an operation mode of an user area, the data processing method comprising the steps of:
i) extracting data from a data storage part in response to the user command in the kernel mode if a predetermined data process command occurs in the user mode by the command of the user;
ii) storing the data in a kernel buffer;
iii) transferring basic information of the data to be processed to the user mode;
iv) creating a second data processing function corresponding to a first data processing function using the basic information in the kernel mode if the first data processing function using the basic information is initiated in the user mode; and
v) processing the data by using the first data processing function.

6. The data processing method as claimed in claim 5, wherein step v) further comprises a step of adding a protocol header for data transmission to data of a transmission unit stored in the kernel buffer.

7. The data processing method as claimed in claim 6, wherein in step v) further comprises a step of adding a protocol header for real-time data transmission is to the data.

8. The data processing method as claimed in claim 7, wherein in step v) further comprises a step of transferring the transmission data to a network device performing data transmission/receiving in relation to an external device by using CODEC information for processing the data having the protocol header for real-time data transmission.
